(19) United States
(12) Patent Application Publication
(10) Pub. No.: US 2016/0067019 A1
(43) Pub. Date: Mar. 10, 2016

(54) Replacement tooth with semi-rigid retention bar and method of manufacture

(71) Applicant: Diane Williams, Chicago, IL (US)

(72) Inventor: Diane Williams, Chicago, IL (US)

(21) Appl. No.: 14/847,912

(22) Filed: Sep. 8, 2015

Related U.S. Application Data
(60) Provisional application No. 62/047,053, filed on Sep. 7, 2014.

(51) Int. Cl. A61C 13/275; A61C 13/267

(52) U.S. Cl. CPC A61C 13/275; A61C 13/267

(57) ABSTRACT

A rear flapper, and a semi-rigid front bar to secure the device against the gum and broken root comprises a replacement tooth with a semi-rigid retention bar. Acrylic thermal beads, which are conventionally used for the creation of dental prosthetics, provide the material for the front bar. The replacement tooth is preferably provided in a variety of sizes and models to replace incisors, canines, or molars, and in a basic ivory color as well as gold and silver.

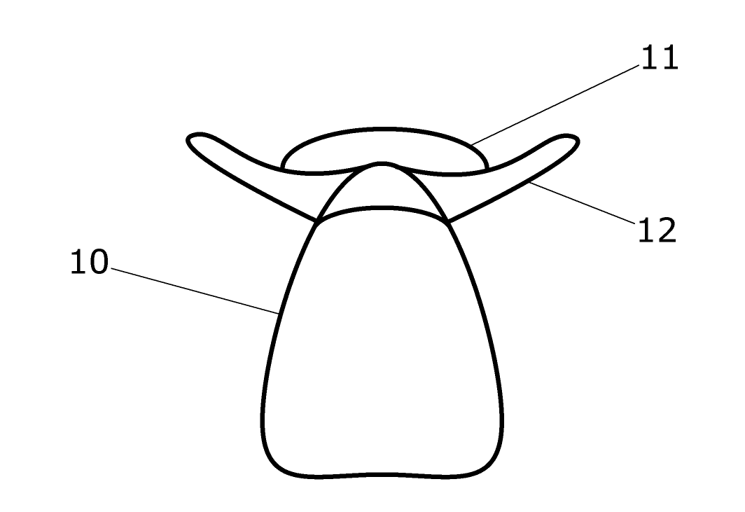

### CROSS-REFERENCE TO RELATED APPLICATIONS

This Application claims the benefit of U.S. Provisional Application No. 62/047,053, filed Sep. 7, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to dental replacement prosthetics and in particular to a replacement tooth with a semi-rigid retention bar. Loss of a tooth, particularly one of the highly visible incisors, can create a serious issue about image and make a person actually refrain from smiling. Various prosthetics and cosmetic replacements are available, but these generally rely on uncomfortable metal bars or glue to be retained in position and often must be removed in order to chew food. A replacement tooth with a semi-rigid retention bar, which can be comfortably secured to the broken root of the original tooth and safely used to chew food, would resolve this problem.

### SUMMARY OF THE INVENTION

Accordingly, the invention is directed to a replacement tooth with a semi-rigid retention bar and the method to manufacture the same. The replacement tooth is comprised of a rigid tooth member, a rear flapper, and a semi-rigid front bar to secure the device against the gum and broken root. Acrylic thermal beads, which are conventionally used for the creation of dental prosthetics, provide the material for the front bar. The replacement tooth is preferably provided in a variety of sizes and models to replace incisors, canines, or molars, and in a basic ivory color as well as gold and silver.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows a front view of the first exemplary embodiment, displaying the tooth member 10, the rear flapper 11, and the front bar 12.

### DETAILED DESCRIPTION OF THE INVENTION

Referring now to the invention in more detail, the invention is directed to a replacement tooth with a semi-rigid retention bar 12 and the method to manufacture the same.

The first exemplary embodiment is comprised of a rigid tooth member 10, a rear flapper 11, and a semi-rigid front bar 12 to secure the device against the gum and broken root. Acrylic thermal beads, which are conventionally used for the creation of dental prosthetics, provide the material for the front bar 12. The replacement tooth is preferably provided in small, medium, and large sizes, in several models to replace incisors, canines, or molars, and in a basic ivory color as well as gold and silver. The rear flapper 11 and the front bar 12 are also provided in long and short lengths to ensure a perfect fit.

To use the first exemplary embodiment, the user slides the device upward into the gap left by the lost tooth, such that the rear flapper 11 is behind the broken root and against the palate, and the front bar 12 rests against the gum and surrounding teeth. The replacement tooth rests in the gap, tight and secure in its position, and may be worn every day and used for chewing food.

Each tooth member 10 is preferably cut from cosmetic novelty secure teeth product. Pink dental acrylic thermal beads are preferably melted to make a front bar 12 to fit across front gums and a rear flapper 11 to fit the upper root of the mouth. The rear flapper 11 is preferably secured with super denture glue and melted thermal beads.

The tooth member 10 is preferably manufactured from a rigid, durable material of substantial hardness, such as ceramics. The rear flapper 11 and the front bar 12 are preferably manufactured from a semi-rigid, durable material, such as acrylic thermal beads.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A replacement tooth with semi-rigid retention bar, comprising:
(a) a tooth;
(b) a front bar;
(c) a rear flapper.
